(19) United States
(12) Patent Application Publication
(10) Pub. No.: US 2009/0307055 A1
(43) Pub. Date: Dec. 10, 2009

(54) Assessing Demand for Products and Services

(76) Inventor: Kevin D. Karty, Lincoln, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/419,060

(22) Filed: Apr. 6, 2009

Related U.S. Application Data
(60) Provisional application No. 61/042,318, filed on Apr. 4, 2008.

(51) Int. Cl. G06Q 10/00

(52) U.S. Cl. 705/10

(57) ABSTRACT

A technique for assessing the viability of several concepts for new/different products, services, or bundles of products and/or services, using discrete choice modeling, or a combination of discrete choice modeling and monadic concept testing. The core of the invention involves one or more of the following: a methodological technique for combining monadic and discrete choice data, a method for gathering monadic and discrete choice data at the same time during a single fielding, a method for gathering specific diagnostic information, a method for using discrete choice modeling to generate specific diagnostic information, a unique web-enabled interface that helps individuals make quick and accurate choices by displaying concepts at low and high resolution at the same time, a unique web-enabled interface that permits gathering choice data on multiple dimensions for each set of concepts shown, methodological innovations permitting hierarchical and/or Bayesian analysis of discrete choice data using data for multiple dimensions within the same model, and methods and apparatus for storing, organizing, and reporting input and output from this system.

### CROSS-REFERENCE TO RELATED APPLICATIONS

This application claims priority to and the benefit of, and incorporates herein by reference, in its entirety, provisional U.S. patent application Ser. No. 61/042,318, filed Apr. 4, 2008.

### TECHNICAL FIELD OF THE INVENTION

This invention relates generally to market research and prototype development, and more specifically to improved techniques and statistical models for screening new products and/or services, in order to determine which have the greatest potential for market success.

### BACKGROUND

Screening concepts for new product and/or service offerings is typically done using either qualitative techniques (focus groups, online focus groups, interviews, expert opinion, etc.) or using simple concept testing in which concepts are tested “monadically” in which self-stated interests in the concept are gathered from potential consumers. The latter approach is generally called “monadic concept testing” and involves consumers reviewing a write-up of a concept and evaluating it across multiple dimensions. The concept may or may not contain one or more images, and usually requires only a single page to present. One variation of monadic concept testing employs sequential testing, in which a single consumer is presented several concepts individually and rates each across multiple dimensions in isolation.

Monadic concept testing has several advantages. First, it is inexpensive to execute. Second, if the sample of consumers or respondents is valid, the results are easily comparable to other monadic tests in a particular category. Third, concepts can be scored on several dimensions. Fourth, for basic monadic concept testing (unlike sequential monadic concept testing), the stimulus is presented freshly to each respondent such that the resulting assessments are unaffected by comparisons to other concepts being presented, but still somewhat dependant on the consumer's knowledge of the marketplace.

Monadic concept testing also has several disadvantages. Chiefly, it has very low statistical power and is thus undiscriminating, and requires very large sample sizes to yield precise estimates. Typical monadic testing is done using 150 respondents per concept (sometimes as few as 75, sometimes as many as 300), and the chief outcomes are “top box” scores and “top two box” scores—that is, binary predictors of whether any individual respondent is or is not likely to buy the product represented by the concept if it were available. For 150 respondents, the output follows a simple binomial distribution which may be reduced to a percentage having a particular distribution. For example, if the underlying mean of the distribution of likeliness to purchase (or any other metric) was observed to be 50%, then the 95% confidence interval for an observed outcome from that distribution is likely to be between 41.8% and 58.2%, a 16.4% band. Moreover, since each monadic score is independent, the comparison of scores between monadic concepts must account for the distribution of both independent scores, and its confidence interval will typically be about \sqrt{2} times larger. Sometimes these monadic scores are adjusted using normative calibration factors. For instance, a “top box” score might be multiplied by 0.8 and a “second box” score might be multiplied by 0.4, with the resulting sum of these two products serving as a weighted metric.

In addition to statistical innaccuracy, monadic testing as a screening tool relies very heavily on aggregate scores. However, many business experts have noted a continuous trend toward fragmentation of product categories. This tends to cause organizations that rely on monadic testing to miss major opportunities—especially in those instances in which small and medium sized consumer segments have strong preferences for a profitable concept, yet the majority of consumers show little or no interest in that concept. It is these niche opportunities that are difficult (and sometimes impossible) to identify due to a lack of any strong correlation to observable consumer characteristics (such as gender, ethnicity, age, etc.). While these niches can represent huge opportunities, monadic testing generally fails to advance concepts with niche appeal by its very nature.

When monadic testing is integrated into a business process such as product development, it can have further pernicious effects. The monadic concept development process tends to encourage linear and closed minded thinking both at an organizational level and an individual level. The organizational theory literature is full of examples in which organizations have invested significant resources into a project and, simply because of that sunk cost, have a very difficult time killing off unpromising ideas once engaged in the development process. In addition, there are numerous examples of the so-called “cognitive blinding” effect in which individuals are less likely to find and recognize a better solution to a problem once a minimally acceptable solution has been presented to them.

Combined with the sheer statistical inaccuracy of monadic concept testing that tends to advance unworthy concepts and reject worthy concepts, as well as the tendency of monadic testing to reject promising concepts with strong appeal to specific market segments, the use of monadic testing as a screening tool tends to soak up tremendous resources, miss major opportunities, and still yield a very high new product failure rate.

### SUMMARY OF THE INVENTION

The invention provides statistical models, techniques, and systems for screening concepts for new products and services that accurately evaluate their potential in the marketplace. More specifically, a set of concepts is scored using both monadic-type data gathering and discrete choice data gathering techniques. Both data types can gather data along one or more dimensions. Conventionally, each choice dimension would be analyzed as a separate model, whereas the invention provides an approach and a set of specific models that can simultaneously consider multiple dimensions and multiple data sources simultaneously or in conjunction to create a combined metric that is more accurate than currently existing metrics, and, in some cases, a model accommodating preference patterns across metrics as well as preference patterns across the marketplace.

Current methods do not incorporate multiple types of data, nor multiple dimensions within the same model. Instead, separate and less information-rich models are built, then interpreted separately. For example, latent class analysis of a two-objective choice dataset typically uses two independent models, each yielding a distinct set of latent classes defining different consumer segments. These classes may or may not significantly overlap, and the models may in fact yield different numbers of latent classes. One approach uses a latent class analysis for one choice dimension, and then uses the resulting classification as input into a second model which is used to further segment the sample. Another approach involves building a single, optimal classification based on observed choices and behaviors across multiple dimensions. In such cases the segments result from grouping respondents demonstrating like-minded behavior along multiple choice dimensions. If desired, one dimension can be given more weight than the other, or they can be given equal weight. When seeking to understand the dynamics within a market, this allows a single, simpler view of market segmentation that optimally uses all available information. A similar approach can be applied using hierarchical Bayesian methods, in which Monte Carlo Markov chain methods are used to account for correlation patterns across respondent behavior. When multiple choice dimensions are present, a single model can be constructed that accounts for correlations across respondents and choice dimensions, not just across respondents and within choice dimensions.

The method for gathering and analyzing respondent data includes simultaneously gathering monadic data and discrete choice data that may be used as input into the modeling approach described above. As an example, respondents are brought into a study, and either prior to or after a discrete choice component of the study (preferably, prior), are asked to rate a monadic concept along one or more dimensions. Each respondent is presented one (or, in some cases more) monadic concept, typically before engaging in the discrete choice study. In some implementations, fewer respondents may see and score each monadic concept than participate in the discrete choice study. For instance, a test of 15 new product concepts may include 750 respondents. Each respondent is shown one concept in a monadic test, such that each concept is seen by approximately 50 respondents, and are then subsequently pooled and brought into a discrete choice component of the study where they see and evaluate several sets of concepts. As another example, each respondent may see 2 or 3 new product concepts, randomly selected from a set of 15, then participate in a sequence of choice tasks. The monadic concepts shown may only partially overlap with the discrete choice concepts, or may fully overlap.

In another aspect, data resulting from both monadic and discrete choice testing is combined by relating data for comparable questions in the monadic and discrete choice studies, and calibrating the parameters estimated in a discrete choice model with the scores from testing the monadic concepts. This approach can be implemented at the concept level by comparing discrete choice parameters for each of the concepts to the average of monadic scores across respondents who viewed that monadic concept. In addition, such an approach can be applied at the individual level by comparing, for each person, the score they gave to the monadic concept they evaluated to their estimated individual-level model parameter for that same concept from the discrete choice model. Further, a calibration factor can be estimated across all concepts or respondents. As a result, all scores can be reported for all the concepts that are comparable to monadic scores from externally executed monadic concepts, and at the same time benefiting from the higher sample size, improved statistical precision, and augmented comparative capability of the discrete choice model. Thus, the technique proposes delivering superior monadic metrics by fusing additional data gathered using a different type of consumer behavior, in this case a choice task or set of choice tasks. The new monadic metrics are more precise better able to discern small differences between concepts, while incorporating many benefits of the discrete choice model.

Several additional metrics may also be calculated for each concept and/or individual that describe aspects of the distribution beyond conventional metrics such as the mean of the parameter distribution (i.e., the average calibrated purchase interest). For instance, the calibrated purchase interest for the top 20% of respondents who were most interested in the product, or another metric of the positive skew of the distribution. The aim is to identify which concepts generate strong, even if narrow, consumer appeal—and thus, which may have niche appeal in market. Other derived metrics can be created from the base metrics as well.

Latent class methods may also be used to identify concepts that have a particular niche appeal in a specific market (or across markets), and as a result, facilitate the characterization of these preference based groups using demographic, attitudinal, and behavioral characteristics gathered, for example, in online surveys and/or other means (e.g., databases of purchasing data, marketing response data, panel membership data, etc.).

In some embodiments, the information relating to the concepts tested, score data, and characteristics of individuals responding to the concepts may be stored in a database to allow comprehensive searching, sorting, filtering, and review of the concepts both individually and as a group, as well as the creation of benchmark values using previously gathered data. The data may, in some cases, also be used to sort, organize, retrieve, and summarize results across multiple studies that enable the tracking and comparing concepts, benchmarking of concepts against other concepts tested in other studies, calibration of concept scores against previous concept scores, and/or in-market product launch data in order to post-launch in-market performance of products or services. Other types of secondary data (demographic, economic, sales data, etc.) may be combined with data from or more studies to allow for better prediction of in-market performance of products or services, either as covariates to improve model precision, as segmentation variables, or as simple profiling data to facilitate targeted marketing or product development efforts.

In another aspect, the invention that facilitates the gathering of discrete choice preference data for concepts for new products and services involves using an online graphical user interface for selecting concepts from a set of concepts. In one embodiment, specific graphical interface elements are presented to respondents as thumbnails of the concepts under study, and the respondents can interact with the thumbnails in a way that change the view of the concepts. For example, the image may be magnified, rotated, or visually modified in some manner to provide additional information or context to the respondent. The interface also provides for the simultaneous viewing of multiple concepts, as well as permitting concepts to be shown in varying resolutions and visible details. Gathering data representative of the respondents' choices includes gathering discrete choice data along multiple dimensions for each set of concepts. For example, a respondent may view a set of three concepts, and make two selections. The method proposes choice dimensions that include, but are not limited to:
“Which concept are you most likely to purchase instead of a product you currently buy?”
“Which concept best fills an un-met need?”
“Which concept is most unique compared to other products on the market?”

### BRIEF DESCRIPTION OF THE FIGURES

In the drawings, like reference characters generally refer to the same parts throughout the different views. Also, the drawings are not necessarily to scale, emphasis instead is generally being placed upon illustrating the principles of the invention.

FIG. 1 is an illustration of a process for determining a qualified responses to the presentation of one or more choices according to one embodiment of the invention.

FIG. 2 is a graphical illustration of respondent data according to one embodiment of the invention.

FIG. 3 is a flow chart illustrating a process for determining responses to the presentation of one or more choices according to one embodiment of the invention.

### DETAILED DESCRIPTION

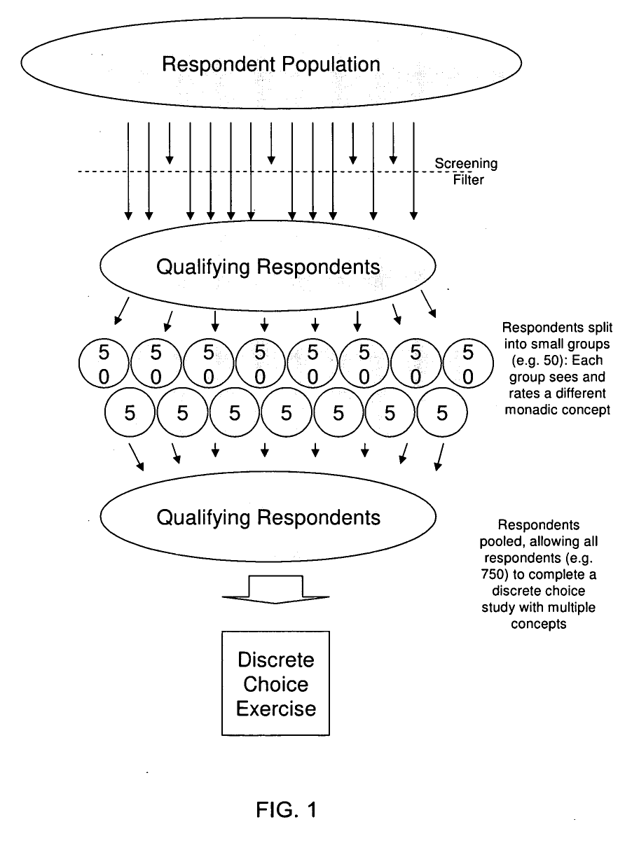

FIG. 1 illustrates one embodiment of a process for gathering data related to respondents' reactions to concepts being tested. An initial population is identified and, in some cases, filtered to eliminated individuals that may be biased, outside the preferred demographic, or for other reasons, resulting in a pool of qualified respondents. The respondents are then split into small groups (e.g., 50 individuals per group), and each group sees and rates a single monadic concept. In one embodiment, each group sees a different concept, whereas in other implementations the same concept may be seen by more than one group. In other embodiments, each individual may see a random or rotating subset of the concepts. After viewing and scoring one or more concepts, respondents are then pooled and all (or some large percentage) complete a discrete choice study that includes multiple concepts.

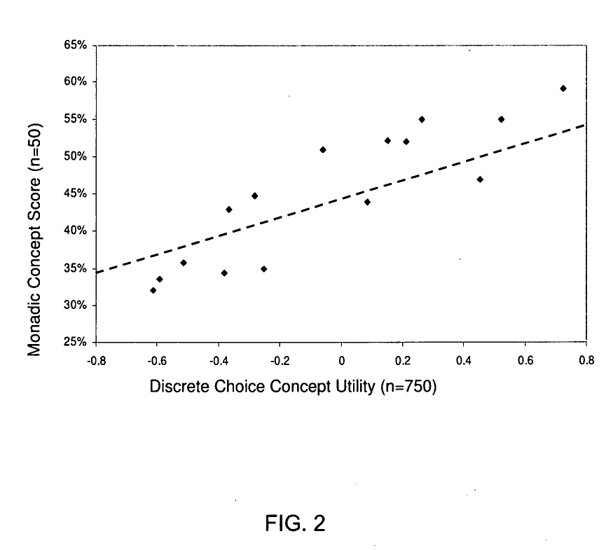

The scores from each of the two exercises are then calibrated across individuals and concepts, as illustrated in FIG. 2. In one approach, a parameter estimate from the discrete choice model for purchase intent and for uniqueness (e.g. the ‘utility’) is associated with each concept. Each concept also has a monadic score for purchase intent and uniqueness (e.g. Top Box, Top Two Box, or Mean score). The monadic scores or some derived metric from the monadic scores may then be regressed against discrete choice parameter estimates of some function of these estimates to yield predicted monadic scores. These predicted monadic scores are more stable and precise (e.g., less noisy) than the original monadic scores.

Alternative approaches may use a non-linear model, a non-parametric model, or an other statistical model to map discrete choice utilities (for either purchase intent or uniqueness or both) to monadic scores (for either purchase intent or uniqueness or both) either at the aggregate level, at the level of specific subgroups or latent preference groups, or at the individual respondent level. As a result, data of one type (model parameter estimates) is converted into data of another type (monadic), thereby capturing the many benefits of a model based approach (reduced or non-existent scale bias, great sample size, comparative estimates, etc.) in a way that yields data that can be used in the same way as monadic data (is portable, is comparable to existing monadic databases, etc.).

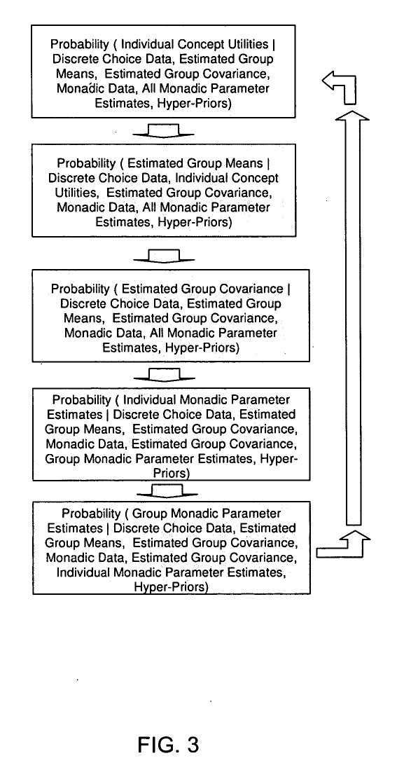

In another embodiment, calibrated, discrete choice concept scores may be combined with monadic test scores to arrive at individual respondent-level scores using imputation and/or a Monte-Carlo-Markov-Chain (MCMC) method, as illustrated in FIG. 3. Initially, individual utilities are calculated, conditional on assumptions and other estimates using, for example, the Metropolis-Hastings method, wherein the accept/reject probability is conditional on its fit with observed data. This results in multivariate, normal individual utility vectors. Next, group mean utilities, conditional on similar assumptions and estimates are used to create multivariate normal group utility vectors. A group covariance structure may then be created, using the same assumptions and estimates, using, for example, inverse Wishart VCV matrix and inverse Chi-Square Sigma techniques.

Next, values that parameterize the monadic response data generating model are calculated, again conditional on the original assumptions and estimates. For example, an ordered logit or probit threshold model in which the individual level utilities are treated as the latent score and the monadic outcome is assumed to be dependent on that score in relation to a set of cutoff points may be used in which these cutoff points are used in the MCMC using a conditional dirichlet distribution. These group and individual level parameter estimates and their posterior distributions can be derived iteratively by repeating the process as described above.

As with all MCMC models, the posterior distribution for all parameters can be estimated using a sequence of sufficiently-spaced draws once the chain has “burned in”. FIG. 3 represents one of several possible Monte Carlo Markov Chains that may be used to calibrate the discrete choice utilities to the monadic scores. This particular chain represents a full information model that estimates all parameters conditional on all data (including both discrete choice and monadic data, as well as all hyper-parameters, at the same time).

Other variations on this model exist. For example, some models use a data augmentation method to estimate some of these parameters in fewer stages—for instance, drawing the monadic parameter estimates as augmented parameters in the Individual Concept Utilities draw phase (and re-parameterizing as necessary). Other models estimate individual level discrete choice utilities and individual level monadic data separately, and still others may incorporate information from other datasets in a way that influences the hyper-priors. As with virtually any MCMC model, there are many small modifications and variations that substantially achieve the same outcome.

Various derived metrics exist that can be constructed from the core metrics being generated in a model such as one of those described above. For example: subsets of scores for individuals who skew positive in the preference for one or more of the concepts; measures of fragmentation of preference related to the overall distribution of preference across concepts and across consumers; measures of consumer commitment; measures of polarization of consumer preferences or sentiment; and various derived metrics that combine one or more of the metrics listed above, as well as other minor variations on these metrics.

1. A method for predicting market success of an offering, the method comprising:
receiving a first set of market research data regarding the offering, the first set being based on one or more discrete choice data collection surveys;
receiving a second set of market research data regarding the offering, the second set being based on one or more monadic data collection surveys;
calibrating the first set of market research with the second set of market research based on commonalities among participants in the discrete choice data collection surveys and the monadic data collection surveys;
modeling the participants predicted affinity for the offering based on the calibrated data.

2. A method for synthesizing improved market success predictors of a specific type by fusing data of a different type, the method comprising:
integrating monadic and discrete choice data along one or more dimensions into a unified model of consumer behavior that can generate superior monadic concept scores at the aggregate or subgroup levels
predicting individual-level monadic scores for individual consumers who have not seen specific concepts, contingent on their responses to one or more concepts and/or one or more choice tasks, along one or more response dimensions, and in combination with the behavior of other individuals
